(19) United States
(12) Patent Application Publication
(10) Pub. No.: US 2006/0292424 A1
(43) Pub. Date: Dec. 28, 2006

(54) Mixing tank and fuel cell system having the same

(76) Inventors: Eun Suk Cho, Yongin (KR); Jun Won Suh, Yongin (KR); Seong Jin An, Yongin (KR)

Correspondence Address: CHRISTIE, PARKER & HALE, LLP, PO BOX 7068, PASADENA, CA, 91109-7068, US

(21) Appl. No.: 11/437,491

(22) Filed: May 18, 2006

(30) Foreign Application Priority Data
Jun. 24, 2005 (KR) 2005-55294

(51) Int. Cl. H01M 8/04; B65D 90/02; B05B 7/04

(52) U.S. Cl. 429/34; 220/565; 239/398

(57) ABSTRACT

Disclosed is a mixing tank for a fuel cell system having a housing, wherein the housing comprises: an inlet portion through which a low concentration fuel and a high concentration fuel are introduced; a mixing portion in which the introduced fuels are mixed; and an outlet portion through which the mixed fuel is discharged, wherein the mixing portion comprises a mixing member to divide a flow of the introduced fuel into a plurality of flows, so that low concentration un-reacted fuel discharged from a stack is uniformly mixed with high concentration fuel, thereby producing hydrogen containing fuel having a predetermined, uniform concentration. Further, a hydrogen containing fuel uniformly mixed and having a predetermined concentration is supplied to a stack, thereby enhancing efficiency of generating electricity.

### CROSS-REFERENCE TO RELATED APPLICATIONS

This application claims priority to and the benefit of Korean Patent Application No. 2005-55294, filed on Jun. 24, 2005, in the Korean Intellectual Property Office, the disclosure of which is incorporated herein by reference.

### BACKGROUND

1. Field of the Invention

The invention relates to a mixing tank for supplying a fuel having a predetermined concentration to a stack in a fuel cell, and more particularly, to a mixing tank and a fuel cell system having the same, in which low concentration, un-reacted fuel, that is discharged from a stack, is uniformly mixed with high concentration fuel so as to recycle the low concentration, un-reacted fuel.

2. Discussion of Related Art

Fuel cell systems have attracted attention as an alternative to solve environmental or resource problems. Fuel cells generate electricity by electrochemically reacting hydrogen, obtained from a hydro-carbonaceous fuel such as natural gas or a hydrogen containing fuel such as methanol, etc., with oxygen in air. Here, the fuel cell is classified into a phosphoric acid fuel cell (PAFC), a molten carbon fuel cell (MCFC), a solid oxide fuel cell (SOFC), a polymer electrolyte membrane fuel cell (PEMFC), or an alkaline fuel cell (AFC), according to type of electrolyte. Further, the fuel cell can be applied to various fields such as mobile devices, transportation, distributed power sources, etc. according to type of fuel, driving temperature, output range, etc.

As compared to other fuel cells, the PEMFC has good output capability, operates at a low temperature, is quickly started, and has a fast response time. Basically, a fuel cell includes a stack with a unit cell to generate electricity based on a chemical reaction between hydrogen gas and oxygen; a reformer to reform the fuel comprising hydrogen, e.g., the hydro-carbonaceous fuel such as methanol, ethanol or natural gas, into the hydrogen gas, and supplying the hydrogen gas to the stack; a fuel feeder supplying the hydrogen containing fuel to the reformer by a pumping operation; and an air feeder supplying air to the stack.

Meanwhile, a direct methanol fuel cell (DMFC) has been researched and developed because it can be miniaturized, it operates at a low temperature, and has a fast response time. Here, the DMFC directly uses the hydrogen containing fuel to generate electricity, without a reformer, to obtain hydrogen gas. The DMFC includes a stack with a unit cell to generate electricity based on the electrochemical reaction between oxygen and hydrogen ions obtained by oxidizing the hydrogen containing fuel; a fuel feeder supplying hydrogen containing fuel to the stack; and an air feeder supplying air to the stack.

In the conventional DMFC, the hydrogen containing fuel is supplied to the stack, thereby generating hydrogen ions. At this time, the hydrogen containing fuel that has not been utilized in the reaction generating the hydrogen ions, i.e., the un-reacted fuel, is discharged along with water (H₂O) produced by the chemical reaction in the stack. Here, the un-reacted fuel decreases the efficiency of the fuel used for generating the electricity in the fuel cell system.

### SUMMARY OF THE INVENTION

Accordingly, one embodiment of the invention provides a mixing tank, in which low concentration, un-reacted fuel discharged from a stack is uniformly mixed with high concentration fuel, thereby producing a hydrogen containing fuel having a predetermined uniform concentration.

Another embodiment of the invention is to provide a fuel cell system, in which a hydrogen containing fuel that is uniformly mixed and has a predetermined concentration is supplied to a stack, thereby enhancing efficiency of generating electricity.

The foregoing and/or other embodiments of the invention are achieved by providing a mixing tank having a housing, wherein the housing comprises: an inlet portion through which a low concentration fuel and a high concentration fuel are introduced; a mixing portion in which the introduced fuels are mixed; and an outlet portion through which the mixed fuel is discharged, wherein the mixing portion comprises a mixing member to divide the flow of the introduced fuel into a plurality of flows.

According to an embodiment of the invention, the housing comprises a filtering portion to remove conductive ions and/or foreign materials from the low concentration fuel. In one embodiment, the filtering portion of the housing comprises an ion exchanger, a porous member, and/or a filter.

According to an embodiment of the invention, the mixing portion of the housing comprises a mixer mounted with a mixing member.

Another embodiment of the invention provides a fuel cell system comprising a stack to generate electricity based on the chemical reaction between hydrogen and oxygen, an air feeder to supply an oxidizing agent to the stack, and a fuel feeder to supply a hydrogen containing fuel to the stack, wherein the fuel feeder comprises fuel storage to store a high concentration fuel, and a mixing tank in which the high concentration fuel supplied from the fuel storage and a low concentration, un-reacted fuel discharged from the stack are introduced and mixed, and the mixing tank comprises a mixing member to divide the flow of the introduced low and high concentration fuels into a plurality of flows.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of schematically illustrating a direct methanol fuel cell (DMFC) according to an embodiment of the invention;

FIG. 2 is a view illustrating a mixing member to be installed in a mixing tank according to an embodiment of the invention;

FIG. 3 is a view illustrating the mixing tank provided with the mixing member of FIG. 2;

FIG. 4 is a sectional view illustrating an example of the mixing tank according to the invention; and

FIG. 5 is a sectional view illustrating another example of the mixing tank according to the invention.

### DETAILED DESCRIPTION OF PREFERRED EMBODIMENTS

Hereinafter, embodiments according to the invention will be described with reference to the accompanying drawings, wherein terms used in describing the embodiments of the invention are defined for the sake of convenience, so that the terms are not limited to and may vary according to intents of those skilled in the art or conventions. Thus, the invention is not limited to the disclosed terms.

For example, in an embodiment the term ‘low concentration fuel’ means an un-reacted fuel that has not participated in the chemical reaction in a stack of a fuel cell system and discharged; the term ‘high concentration fuel’ means a high purity fuel which is not mixed with water, and selected from a fuel group consisting of an alcoholic fuel such as methanol, ethanol, etc., a hydro-carbonaceous fuel such as methane, propane, butane, etc., or a natural gas fuel such as liquefied natural gas, etc., and combinations thereof; and the term ‘hydrogen containing fuel’ means a fuel supplied to the stack.

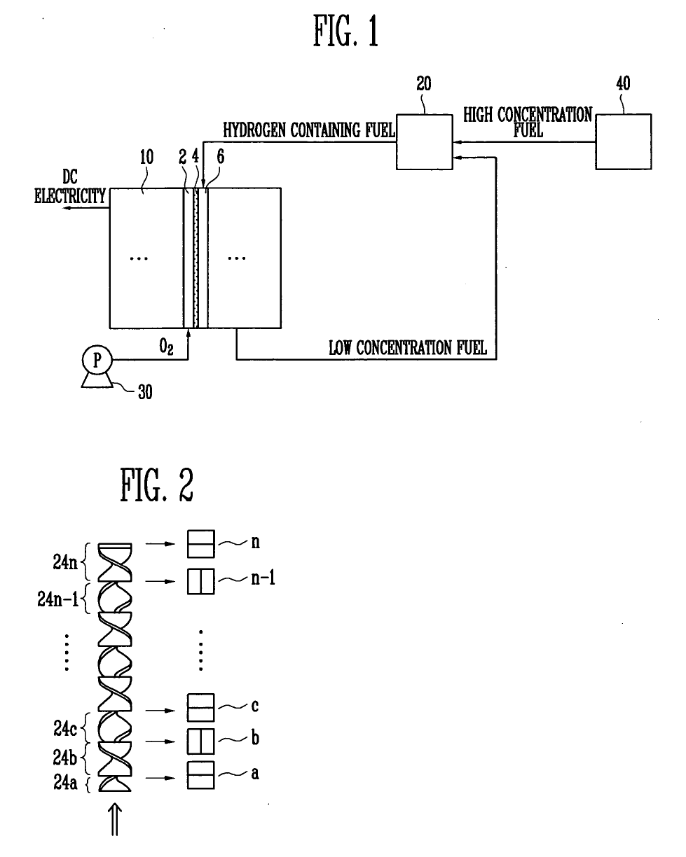

According to one embodiment, as shown in FIG. 1, a DMFC includes a stack 10 to generate electricity by the chemical reaction between hydrogen and oxygen; an air feeder 30 to forcibly supply an oxidizing agent, e.g., oxygen or oxygen containing air to the stack 10; and a mixing tank 20 to supply a hydrogen containing fuel to the stack 10. In the mixing tank 20, a high concentration fuel stored in fuel storage unit 40, and a low concentration, un-reacted fuel discharged from the stack 10, are mixed.

Further, in another embodiment, the DMFC can include a recovery tank (not shown) to recover the low concentration, un-reacted fuel discharged from the stack 10. Here, the recovery tank can be provided in a line between the stack 10 and the mixing tank 20.

In an embodiment, the stack 10 includes a plurality of unit cells, each of which has a membrane electrode assembly (MEA) including a polymer membrane 4, a cathode electrode 2, and an anode electrode 6 on opposite sides of the polymer membrane 4.

In an embodiment, the anode electrode 6 oxidizes the hydrogen containing fuel supplied from the mixing tank 20, thereby generating a hydrogen ion H⁺ and an electron e⁻. At this time, the hydrogen ion H⁺ moves toward the cathode electrode 2 through the polymer membrane 4, and the electron e⁻ moves toward the cathode electrode 2. In the cathode electrode 2, water is produced by the chemical reaction between oxygen in the air supplied from the air feeder 30, and the hydrogen ion H⁺ moved through the polymer membrane 4.

In an embodiment, the polymer membrane 4 is a conductive polymer electrolyte membrane having the ion exchange function of transferring the hydrogen ion generated in the anode electrode 6 to the cathode electrode 2, and the function of preventing the hydrogen containing fuel from penetrating into the cathode electrode. In one embodiment, the polymer membrane 4 has a thickness of about 50 to 200 μm.

In one embodiment, the oxidation reaction of the hydrogen containing fuel in the anode electrode 6 produces carbon dioxide CO₂, and the reduction reaction of oxygen in the cathode electrode 2 produces water H₂O, and at this time, the low concentration, un-reacted fuel, which has not participated in the oxidation reaction in the anode electrode 6, is discharged from the stack 10 along with water H₂O.

In an embodiment, the air feeder 30 is provided with a driving pump P for supplying air to the cathode electrode 2 of the stack 10.

Meanwhile, in an embodiment, a first supply line for the low concentration, un-reacted fuel is located between the stack 10 and the mixing tank 20, and a second supply line for the high concentration fuel is located between the fuel storage and the mixing tank 20. Thus, in one embodiment, the low concentration, un-reacted fuel and the high concentration fuel are supplied to the mixing tank 20 through the first channel and the second channel, respectively, and then mixed to produce a fuel with a predetermined concentration. In an embodiment, for example, a hydrogen containing fuel having a concentration of 1M is supplied to the anode electrode 6 of the stack 10.

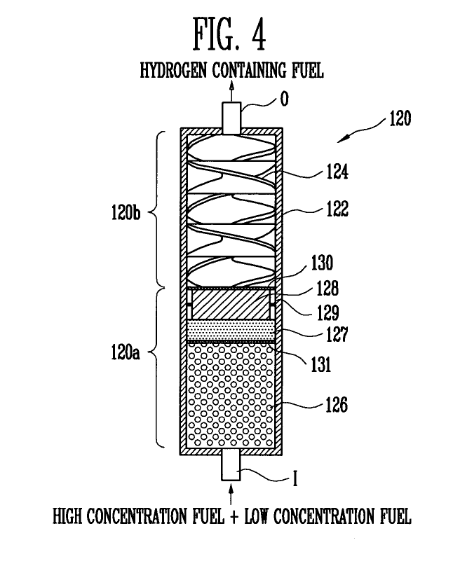

Referring to FIG. 3, in one embodiment, the mixing tank 20 includes a housing 22 having a first side formed with an inlet 20a, and a second side formed with an outlet 20b. The housing 22 is provided with a plurality of mixing members 24 to divide the flow of the low and high concentration fuels introduced through the inlet 20a into a plurality of flows.

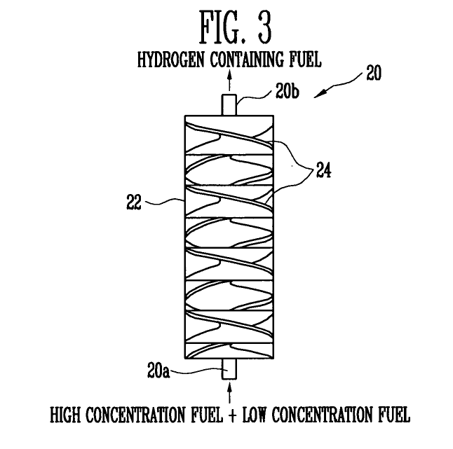

In one embodiment, as shown in FIG. 2, the plurality of mixing members 24 are stacked and aligned with each other, so that the low concentration fuel and the high concentration fuel are introduced through the inlet 20a and mixed while flowing through the mixing member 24. That is, the fluid is divided into two flows, passing through a first discharging terminal a of first mixing member 24a adjacent to the inlet 20a. In a different direction, the fluid is divided into two flows, passing through a second discharging terminal b of a second mixing member 24b adjacent to the first mixing member 24b. Thus, the low concentration fuel and the high concentration fuel are mixed while passing through the mixing member 24 by the foregoing flow-division process. In another embodiment, in the mixing tank 20 the flow-division process is not limited to two flows of the fuel, and may divide the fluid into a plurality of flows.

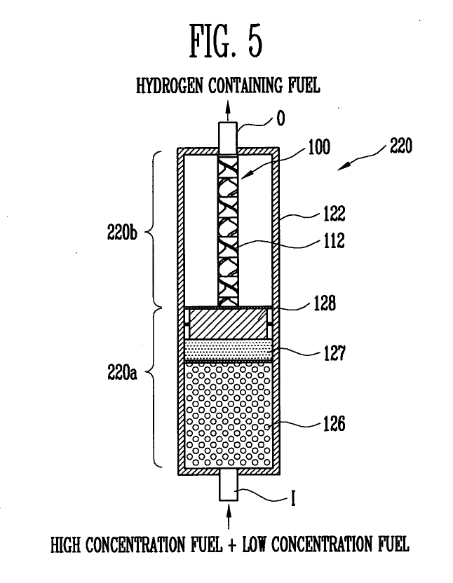

In one embodiment, the low concentration, un-reacted fuel, which has not participated in the chemical reaction in the stack 10, and is discharged, may contain impurities such as foreign materials and/or conductive ions. Thus, as shown in FIG. 4, the mixing tank 120 according to an embodiment of the invention can include an ion exchanger 126 such as an ion exchange resin to remove the conductive ion, and/or a porous member 127 to remove the impurities. In an embodiment, the mixing tank 120 includes a filtering portion 120a and a mixing portion 120b. In an additional embodiment, the filtering portion 120a includes the ion exchanger 126 and/or the porous member 127, and the mixing portion 120b includes the mixing member 124.

Referring to FIG. 4, in one embodiment, the ion exchanger 126 is placed adjacent to the inlet I through which the high concentration fuel and the low concentration fuel are introduced, thereby removing conductive ions contained in the low concentration fuel. Here, the ion exchanger 126 is formed by stacking a positive ion exchange resin or a negative ion exchange resin to a predetermined thickness. Therefore, while the fuel introduced through the inlet I passes through the ion exchanger 126, the conductive ions are removed from the low concentration fuel. At this time, the low concentration fuel and the high concentration fuel are first mixed.

In one embodiment, the mixed fuel comprising the low concentration fuel and the high concentration fuel passing through the ion exchanger 126 passes through the porous member 127 and/or the mixing member 124. While the mixed fuel passes through the porous member 127, the impurities are removed from the mixed fuel.

In an embodiment, a mesh screen 131 can be provided between the ion exchanger 126 and the porous member 127, thereby preventing the ion exchange resin of the ion exchanger 126 from being introduced to the porous member 127.

In an embodiment, to more effectively remove the impurities from the low concentration fuel, the filtering portion 120a of the mixing tank 120 is provided with a filter 128, placed above the porous member 127 in the flowing direction of the fuel. The filter 128 is coupled to the mixing tank 120 by an O-ring 129 around the circumference the filter 128. Further, in an embodiment, a mesh screen 130 can be placed above the filter 128. That is, the housing 122 of the mixing tank 120 includes a filtering portion 120a to remove the foreign material and/or the conductive ions from the fuel through the mesh, and a mixing portion 120b to mix the high concentration fuel with the low concentration fuel.

According to another embodiment of the invention as shown in FIG. 5, a mixing portion 220b of a mixing tank 220 is provided with a mixer 100 fluid-flowably connected to an outlet O. As shown in FIG. 5, the mixer 100 includes a housing mounted with a mixing member 112 to divide the flow of fuel, which is introduced after being filtered through a filtering portion 220a of the mixing tank 220, into a plurality of flows. Here, the housing of the mixer 100 has a discharging end fluid-flowably connected to the outlet O. Thus, the fuel filtered through the filtering portion 220a is mixed, passing through the mixer 100. Then, the mixed fuel is supplied to the stack 10 through the outlet O of the mixing tank 220 via the discharging end of the housing.

Below, operation of the fuel cell system with the mixing tank according to an embodiment of the invention will be described.

In one embodiment, the hydrogen containing fuel having a predetermined concentration, i.e., a concentration of 1M is supplied to the anode electrode 6 of the stack 10, and an oxidizing agent such as oxygen is supplied from the air feeder 30 to the cathode electrode 2 of the stack 10. Thus, the electricity is generated by oxidation-reduction reaction in the stack 10.

The oxidation-reduction reaction causes water to be produced, and the un-reacted fuel, which has not participated in the chemical reaction in the anode of the stack 10, is discharged along with water. In an embodiment, as a result, the low concentration un-reacted fuel is introduced to the mixing tank 20, and mixed with the high concentration fuel supplied from fuel storage 40.

In one embodiment, in the mixing tank 20 (refer to FIG. 3), the high concentration fuel and the low concentration fuel introduced through the inlet 20a, are mixed while passing through the mixing member 24, thereby maintaining a predetermined concentration, e.g., a concentration of 1M. Then, the hydrogen containing fuel having this concentration is supplied to the anode electrode 6 of the stack 10.

In an embodiment, in the mixing tank 120 (refer to FIG. 4), while passing through the filtering portion 120a, the impurities and/or the conductive ion are removed from the high concentration fuel and the low concentration fuel introduced through the inlet I. Thus, the high and low concentration fuels are introduced to the mixing portion 120b, without the impurities and/or the conductive ions. Then, the high and low concentration fuels are mixed to a predetermined concentration, e.g., a concentration of 1M while passing through the mixing member 124 of the mixing portion 120b. Finally, the hydrogen containing fuel having this concentration is supplied to the anode electrode 6 of the stack 10.

In the mixing tank 220 (refer to FIG. 5), while passing through the filtering portion 220a, the impurities and/or the conductive ions are removed from the high concentration fuel and the low concentration fuel introduced through the inlet I. Thus, the high and low concentration fuels are introduced to the mixing portion 220b, without containing the impurities and/or the conductive ions. Then, the high and low concentration fuels are introduced to the housing of the mixer 100 provided in the mixing portion 220b, and mixed to a predetermined concentration, e.g., a concentration of 1M while passing through the mixing member 112. Finally, the hydrogen containing fuel having this concentration is supplied to the anode electrode 6 of the stack 10.

As described above, the low concentration fuel and the high concentration fuel are uniformly mixed while passing through the mixing member 24, 112, 124, so that the hydrogen containing fuel, having a uniform concentration, is supplied to the stack 10, thereby enhancing the efficiency of generating electricity.

Although a few embodiments of the invention have been shown and described, it would be appreciated by those skilled in the art that changes might be made in these embodiments without departing from the principles and spirit of the invention, the scope of which is defined in the claims and their equivalents.

What is claimed is:

1. A mixing tank for a fuel cell system having a housing comprising:
an inlet portion through which a low concentration fuel and a high concentration fuel are introduced;
a mixing portion comprising a mixing member adapted to divide the flow of the introduced fuels into a plurality of flows in which the introduced fuels are mixed; and
an outlet portion through which the mixed fuel is discharged.

2. The mixing tank according to claim 1, wherein the low concentration fuel comprises conductive ions and/or foreign materials and the housing comprises a filtering portion to remove the conductive ions and/or foreign materials from the low concentration fuel.

3. The mixing tank according to claim 2, wherein the filtering portion of the housing comprises an ion exchanger.

4. The mixing tank according to claim 2, wherein the filtering portion of the housing comprises a porous member.

5. The mixing tank according to claim 2, wherein the filtering portion of the housing comprises a filter.

6. The mixing tank according to claim 1, wherein the mixing portion of the housing comprises a mixer with a mixing member.

7. The mixing tank according to claim 6, wherein the inlet portion of the housing comprises the filtering portion.

8. The mixing tank according to claim 2, wherein the mixing portion of the housing comprises a mixer with a mixing member.

9. The mixing tank according to claim 8, wherein the inlet portion of the housing comprises the filtering portion.

10. A fuel cell system comprising:
a stack to generate electricity,
an air feeder adapted to supply an oxidizing agent to the stack; and
a fuel feeder adapted to supply hydrogen containing fuel to the stack, wherein the fuel feeder comprises:
fuel storage to store a high concentration fuel; and,
mixing tank comprising a mixing member adapted to divide the flow of the introduced low and high concentration fuels into a plurality of flows in which the high concentration fuel supplied from the fuel storage and low concentration, un-reacted fuel discharged from the stack, are introduced and mixed.

11. The fuel cell system according to claim 10, wherein the mixing tank comprises a filtering portion to remove conductive ions and/or foreign materials from the low concentration fuel.

12. The fuel cell system according to claim 11, wherein the filtering portion comprises an ion exchanger.

13. The fuel cell system according to claim 11, wherein the filtering portion comprises a porous member.

14. The fuel cell system according to claim 11, wherein the filtering portion comprises a filter.

15. The fuel cell system according to claim 10, wherein the mixing tank comprises a mixer with a mixing member.

16. The fuel cell system according to claim 11, wherein the mixing tank comprises a mixer with a mixing member.
